(19) United States
(12) Patent Application Publication
(10) Pub. No.: US 2026/0228444 A1
(43) Pub. Date: Aug. 6, 2026

(54) SPEAKER MODULES IN AN AUDIO-VISUAL REAL-TIME TRANSCRIPTION SYSTEM

(71) Applicant: RTC Vision Ltd., Rosh HaAyin (IL)

(72) Inventors: Ron WEIN, Herzliya (IL); Joseph RUBNER, Shoham (IL); Nir AVRAHAMI, Herzliya (IL); Nir TSUK, Tel Aviv (IL); Kfir GEDALYAHU, Ganey Tikva (IL)

(73) Assignee: RTC Vision Ltd., Rosh HaAyin (IL)

(21) Appl. No.: 19/044,674

(22) Filed: Feb. 4, 2025

(51) Int. Cl. G06F 40/35

(52) U.S. Cl. CPC G06F 40/35

(57) ABSTRACT

The present invention provides a system and method for real-time target speaker recognition and transcription, enhancing accuracy in noisy and multi-speaker environments. Using audio and video inputs from a microphone and camera, the system processes features through neural networks, including cross-attention mechanisms, to isolate speaker-specific data and suppress noise. A Speaker Module tracks and identifies active speakers via face detection, recurrent neural networks, or decision mechanisms, ensuring transcription continuity even with temporary visual occlusions. Outputs generated by the invention include transcribed text and speaker labels, displayed on an augmented reality display or a mobile device as real-time subtitles. The system can suppress the display of the user's own speech for improved usability and supports multilingual transcription. This invention offers a robust solution for individuals with hearing impairments, enabling accurate comprehension in challenging acoustic settings.

### FIELD AND BACKGROUND OF THE INVENTION

The present invention, optionally, relates to systems and methods for speech transcription and, more particularly, but not exclusively, to systems and methods incorporating audio-visual processing for real-time transcription and speaker identification.

Speech transcription systems are widely used in various fields, including accessibility tools for individuals with hearing impairments, voice-controlled interfaces, and automated meeting documentation. Traditional speech-to-text systems primarily rely on audio inputs from microphones to convert speech into text. Such systems have achieved significant advancements in recent years, largely due to the development of deep learning and neural network-based models. These models utilize features extracted from audio signals, such as spectrograms, and process them to generate accurate transcriptions.

Despite these advances, existing systems face notable challenges in noisy environments or when multiple speakers are present. Conventional hearing aids, for example, amplify sound but are often insufficient in environments with loud background noise or overlapping conversations. This limitation particularly affects individuals with hearing impairments, who may struggle to distinguish the speech of a specific speaker amidst competing sounds.

Another area of interest involves differentiating between speakers in real-time transcription. Speaker diarization, or the process of determining “who spoke when,” is a critical component in multi-speaker scenarios. Technologies in this field often rely on clustering audio features to segment and label speech utterances by speaker. While effective to some extent, these systems may struggle to provide disambiguating information.

### SUMMARY OF THE INVENTION

As used herein, the term “real-time” means the capability of a system to process, analyze, and produce outputs, such as speaker labels and text transcriptions, with minimal latency, such that the outputs are generated substantially concurrently with the receipt of the input streams.

Optionally, a method for target speaker recognition and transcription of speech comprises receiving audio and video streams from respective inputs, computing initial features from the streams, enhancing the audio features based on correlations with processed video features using a neural network, generating target speaker features by processing the initial and enhanced features, and producing outputs including speaker labels and text transcriptions, optionally leveraging auxiliary data streams, recurrent neural networks, transformer architectures, and prioritization mechanisms for enhanced real-time performance.

According to an aspect of some embodiments of the present invention, provided is a method of target speaker recognition and transcription of speech, comprising: receiving an audio stream from a first input; receiving a video stream from a second input; computing a plurality of initial audio features from the audio stream; computing a plurality of initial video features from the video stream; applying a neural network to the plurality of initial video features, thereby generating a plurality of extended video features; determining a correlation between the plurality of initial audio features and the plurality of extended video features, thereby generating a plurality of enhanced audio features; processing the plurality of initial audio features, the plurality of initial video features, and the plurality of enhanced audio features, thereby generating a plurality of target speaker features; and generating an output.

Optionally, the method further comprises receiving a data stream from a third input and computing a plurality of initial auxiliary features from the data stream, wherein generating a plurality of target speaker features comprises processing the plurality of initial audio features, the plurality of initial video features, the plurality of enhanced audio features, and the plurality of initial auxiliary features.

Optionally, the neural network comprises at least one convolution layer.

Optionally, generating the plurality of enhanced audio features comprises performing a computation solely on the plurality of extended video features.

Optionally, generating the plurality of enhanced audio features comprises one or more of: applying at least one cross-attention layer to the plurality of initial audio features and the plurality of extended video features; applying a recurrent neural network to the plurality of initial audio features, the plurality of initial video features, and a plurality of previously computed target speaker features; and utilizing a decision process to the plurality of initial audio features, the plurality of initial video features, and a plurality of previously computed target speaker features.

Optionally, generating the plurality of target speaker features comprises applying a recurrent neural network to the plurality of initial audio features, the plurality of initial video features, and the plurality of enhanced audio features.

Optionally, generating an output comprises applying a machine learning model to the plurality of target speaker features, thereby generating a target speaker label; and outputting the target speaker label.

Optionally, generating an output comprises applying positional encoding to the plurality of enhanced audio features; applying at least one transformer encoder layer, thereby generating a sequence of encoded vectors; applying a transformer decoder layer to the sequence of encoded vectors, thereby generating a sequence of textual tokens; concatenating the sequence of textual tokens, thereby generating a text transcription; and outputting the text transcription.

Optionally, the method further comprises applying a machine learning model to the plurality of target speaker features and at least one of a previously obtained text transcription and a previously obtained plurality of textual tokens, thereby generating a target speaker label; and outputting the target speaker label.

Optionally, the method further comprises determining whether a condition is met, wherein the condition comprises checking whether the target speaker label equals a predetermined speaker label; and responsive to determining that the condition is met, skipping the step of outputting the text transcription.

Optionally, computing a plurality of initial audio features comprises receiving an audio signal from a microphone device; computing a spectrogram of the audio signal; and applying at least one convolution layer to the spectrogram.

Optionally, computing a plurality of initial video features comprises receiving a frame sequence from a camera device; responsive to detection of one or more faces within a frame in the frame sequence, determining a bounding box for each detected face; and extracting from the frame a 2-dimensional (2D) array of pixels limited by the respective bounding box for each detected face.

Optionally, the method further comprises, responsive to detecting the absence of a target speaker in the plurality of video streams: skipping the step of generating a plurality of extended video features; skipping the step of generating a plurality of enhanced audio features; and processing the plurality of initial audio features, thereby generating a plurality of target speaker features; and generating an output.

Optionally, the method further comprises detecting a particular face at the center of each frame in the frame sequence of a configured duration; tracking the detected face across subsequent frames; and prioritizing the target speaker features corresponding to the tracked face across subsequent frames.

Optionally, the method further comprises receiving a signal to select a particular face from a third input; tracking the selected face across subsequent frames; and prioritizing the target speaker features corresponding to the tracked face across subsequent frames.

According to an aspect of some embodiments of the present invention, provided is a computer system, comprising: one or more microphone devices; one or more camera devices; a processor configured to execute stored executable instructions; and a non-transitory computer-readable medium storing executable instructions that, when executed by a processor, cause the computer system to perform a method of target speaker recognition and transcription, the method comprising: receiving one or more audio streams as a first input; receiving one or more video streams as a second input; computing a plurality of initial audio features from the one or more audio streams; computing a plurality of initial video features from the one or more video streams; applying a neural network to the plurality of initial video features, thereby generating a plurality of extended video features; determining a correlation between the plurality of initial audio features and the plurality of extended video features, thereby generating a plurality of enhanced audio features; processing the plurality of initial audio features, the plurality of initial video features, and the plurality of enhanced audio features, thereby generating a plurality of target speaker features; and generating an output.

Optionally, the computer system further comprises one of an augmented reality display and virtual reality display, wherein generating an output comprises rendering a text transcription on one of the augmented reality display, an auxiliary screen, an auxiliary projector or a virtual reality display or a virtual reality display.

Optionally, at least one of the one or more microphone devices and the one or more camera devices is coupled to the processor via at least in part a wireless link.

Optionally, the wireless link comprises one of a Bluetooth, Wi-Fi, Wi-Fi Direct, Wi-Fi HaLow, Ultra-Wideband, mmWave, 5G, and LiFi connection.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a baseline audio-visual transcription system, according to some embodiments of the invention;

FIG. 2 is a block diagram of an enhanced transcription system, according to some embodiments of the invention;

FIG. 3 is a schematic diagram of the speaker module, according to some embodiments of the invention; and

FIG. 4 is a schematic representation of an AR glasses view, according to some embodiments of the invention.

### DESCRIPTION OF SPECIFIC EMBODIMENTS OF THE INVENTION

Research studies demonstrate that incorporating visual cues, such as lip movements and facial expressions, can enhance speech recognition accuracy, especially in noisy or multi-speaker settings. Visual data, however, presents its own challenges, such as temporary occlusion of a speaker's face or camera misalignment, which must be addressed for practical implementation.

The method described hereinbelow enables accurate transcription by leveraging synchronized audio-visual data to isolate and enhance speaker-specific audio features, even in the presence of loud background noise or overlapping speech.

The method described hereinbelow is particularly useful for facilitating one-to-one or multi-speaker conversations for people suffering from hearing loss, enhancing their ability to follow discussions in challenging acoustic conditions, such as meetings, family gatherings, or public spaces.

The present invention, optionally, relates to systems and methods for speech transcription and, more particularly, but not exclusively, to systems and methods incorporating audio-visual processing for real-time transcription and speaker identification.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

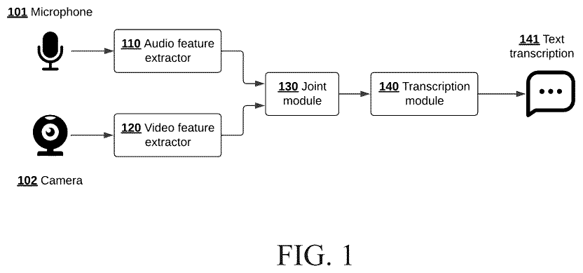

Referring now to the drawings, FIG. 1 illustrates the diagram of a baseline audio-visual transcription system. According to some embodiments of the invention, the system comprises a microphone 101, a camera 102, an audio feature extraction module 110, a video feature extraction module 120, a joint module 130 and a transcription module 140.

In an embodiment, the audio feature extraction module 110 is configured to receive audio input data from the microphone 101, process the audio input data and generate a sequence of initial audio features.

By way of illustration, the audio input data provided by the microphone 101 may be sampled at a frequency of 16 kHz, and the sequence of initial audio features generated by the audio feature extraction module 110 may comprise a plurality of feature vectors, each corresponding to a time frame of 10 milliseconds in duration.

Optionally, an audio feature may be derived from a short-time signal spectrum. Optionally, an audio feature may be generated by a neural network that is trained to extract audio features from the input data. For example, an audio feature may include, but is not limited to, the output of a log-spectrogram, a Mel-frequency cepstral coefficient, an output of a fast Fourier transform, or an energy level within a specific frequency band.

Optionally, the audio feature extraction module 110 computes a log-Mel spectrogram of the audio input data using C frequency channels, a window size of w milliseconds and a stride of s milliseconds, thereby outputting a tensor of a dimension

$$[ \frac{T}{s} ] \times C ,$$

wherein T is the duration of the audio sample size in seconds. By way of illustration, C=80, w=25 ms, s=10 ms, and the dimension of the tensor is [100·T]×80.

As used herein, the term “convolution layer” refers to a neural network layer that applies a set of learnable filters to the input data. Each filter convolves over the input, performing a localized operation to extract spatial or temporal features such as patterns in amplitude, frequency, or time. The output of a convolution layer, also referred to as a feature map, captures the presence and location of specific patterns relevant to the task.

Optionally, the audio feature extraction module 110 further applies 2 layers of 1-dimensional convolution to the log-Mel spectrogram of the audio input data, outputting a tensor of a dimension [R·T]×W, wherein T is the duration of the audio sample size in seconds, R is the audio feature rate in vectors per second, and W is the width of an audio feature vector, representing local acoustic characteristics of a brief time interval. In an example, W=1280 and R=50 Hz.

In an embodiment, the video feature extraction module 120 is configured to receive video input data from the camera 102, process the video input data and generate a sequence of initial video features.

By way of illustration, the video input data may comprise a sequence of RGB frames captured at a rate of F frames per second, wherein a typical range of F may comprise 25-30 Hz.

Optionally, the video feature extraction module 120 is configured to perform face detection within each frame and compute features associated with the region corresponding to the detected face.

In an embodiment, the video feature extraction module 120 utilizes a machine learning model to detect a speaker face in each RGB frame in the video input data and to obtain the location of facial landmarks of the speaker face such as the the right and left eyes, the upper and lower lips within each RGB frame. In an example embodiment, the machine learning model comprises the Google MediaPipe model.

Optionally, the video feature extraction module 120 further computes a bounding box around the mouth of the speaker face, and resizes the bounding box to a grayscale image of a size w_{bb}×h_{bb}. By way of illustration, the dimensions of the grayscale image may comprise w_{bb}=112 px and h_{bb}=112 px.

Optionally, the video feature extraction module 120 further resamples the sequence of grayscale images to a rate of F RGB frames per second and outputs the sequence to a 3-dimensional convolution network, thereby generating a tensor of a dimension [F·T]×V, wherein T is the duration of the video sample size in seconds, and V is the size of an initial video feature vector for a single speaker face. By way of illustration, the frame rate F=25 Hz, and V=512.

In an embodiment, the joint module 130 receives the [F·T]×V tensor of initial video features from the video feature extraction module 120, the [R·T]×W tensor of initial audio features from the audio feature extraction module 110, and performs feature enhancement for speech transcription. Such feature enhancement provides advantages in case of noisy environments, presence of a cross-talk or a background talk.

Optionally, the joint module 130 utilizes visual information on a speaker's face and in particular on a speaker's lips to discard or diminish the audio features that were induced by a background noise or a cross-talk, and retain solely or mostly the audio features induced by a speaker's voice. For example, the machine learning model within the joint module 130 may be trained on an extensive dataset containing video clips of a speaker's face as a baseline, augmented with various types of background noise, interference signals, differing signal-to-noise ratios, and cross-talk scenarios. During operation, the joint module 130 processes audio features alongside corresponding video features, learning to suppress audio features associated with interference signals and to enhance features related to the speaker's voice. This approach significantly improves the quality and accuracy of the resulting transcription.

As used herein, the term “extended video features” means a plurality of video features processed to align in dimensions to the respective plurality of audio features.

Optionally, the joint module 130 applies a neural network to the tensor of initial video features. In an embodiment, the joint module 130 applies 2 layers of 1-dimensional convolution to the tensor of initial video features, and outputs a plurality of extended video features, thereby generating a tensor of a dimension [R·T]×W.

As used herein, the term “enhanced audio features” means a plurality of audio features modified with respect to relevant video features produced from video input data captured by a camera 102.

As used herein, the term “cross-attention layer” refers to a neural network layer that computes attention scores between two distinct input sequences, such as a sequence of initial audio features and a sequence of extended video features. The cross-attention mechanism assigns weights to elements in one sequence based on their relevance to elements in the other sequence, enabling the network to model interactions and dependencies between the two input modalities.

Optionally, the joint module 130 further determines a correlation between the plurality of initial audio features and the plurality of extended video features, thereby generating a plurality of enhanced audio features. In an embodiment, the joint module 130 applies one or more cross-attention layers between the initial audio features and the extended video features, and outputs a plurality of enhanced audio features, thereby generated a tensor of a dimension [R·T]×W.

Optionally, the joint module 130 performs a computation solely on the plurality of extended video features to generate a plurality of enhanced audio features. For example, such an approach may offer an advantage when the audio input is unavailable for a short period of time.

In an embodiment, the transcription module 140 receives the [R·T]×W tensor of enhanced audio features from the joint module 130, and performs text transcription.

In another embodiment, the transcription module 140 receives the [R·T]×W tensor of initial audio features directly from the audio feature extraction module 110, and performs text transcription, thereby skipping generation of extended video features and generation of enhanced audio features. For example, such an approach may offer an advantage when the video input is unavailable for a short period of time.

Optionally, the transcription module 140 zero-pads the enhanced audio features to a preconfigured value of T.

As used herein, the term “transformer encoder layer” refers to a neural network layer within a transformer architecture that processes a single input sequence by applying self-attention and feed-forward mechanisms. The self-attention mechanism calculates attention scores within the input sequence, capturing dependencies across all elements, while the feed-forward mechanism applies learned transformations to enhance feature representation.

As used herein, the term “transformer decoder layer” refers to a neural network layer within a transformer architecture that processes two input sequences, the first input sequence representing the target sequence and the second input sequence providing contextual information, such as the output of a transformer encoder layer. The transformer decoder layer incorporates both self-attention for dependencies within the target sequence and cross-attention to align the target sequence with the contextual information.

Optionally, the transcription module 140 applies a sinusoidal positional encoding to each feature vector in the plurality of enhanced audio features. Optionally, the transcription module 140 further applies one or more layers of transformer encoder blocks, thereby generating a sequence of encoded vectors. Optionally, the transcription module 140 further submits the sequence of encoded vectors to a layer of decoder blocks, thereby computing a sequence of output tokens. Optionally, the transcription module 140 further concatenates the sequence of output tokens to generate an output text transcription 141.

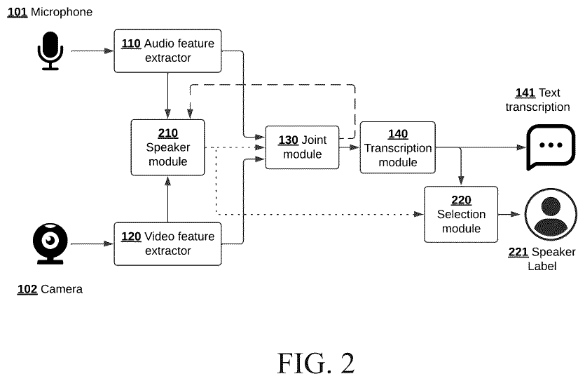

Reference is now made to FIG. 2, which is a block diagram of an enhanced transcription system. In the present invention, speaker characteristics are defined and tracked to enable a robust association between audio and video features corresponding to specific speakers. The speaker characteristics enhance the accuracy and robustness of transcription, even in the presence of significant background noise and multiple simultaneous speakers. According to some embodiments of the invention, to accomplish this objective, additional modules are incorporated into the system.

As used herein, the term “speaker features” means a plurality of features encoding an identity of a speaker.

In an embodiment, the speaker module 210 receives a plurality of initial video features 310 from the video feature extractor module 120 and a plurality of initial audio features 320 from the audio feature extractor module 110, and performs a computation to generate a plurality of speaker features 340.

In another embodiment, the speaker module 210 additionally receives a plurality of enhanced audio features 330 from the joint module 130 via a feedback loop, and utilizes it in the subsequent computation to generate a plurality of speaker features 340.

Optionally, the speaker module 210 applies a recurrent neural network to the input features, outputting a vector of a preconfigured dimension D for each time frame, the vector encoding an identity of a speaker during the time frame, thereby generating a tensor of a dimension [R·T]×D as a plurality of speaker features 340.

Optionally, the video feature extraction module 120 generates a tensor of a dimension [F·T]×V×k, comprising initial video feature vectors for a plurality of k detected speaker faces, wherein T is the duration of the video sample size in seconds, F is the frame rate of the RGB frames captured by the camera 102, and V is the size of an initial video feature vector.

Optionally, responsive to a previously observed face becoming occluded or going out of focus, the video feature extraction module 120 replaces a respective mouth image with a blank image of a dimension w_{bb}×h_{bb}, and the corresponding portion of the initial video features is replaced with a zero tensor.

Optionally, the joint module 130 receives the plurality of speaker features 340 from the speaker module 210, and utilizes it to control the identity and the weight of the initial video features used to compute the enhanced audio features. In other words, the joint module 130 utilizes the plurality of speaker features 340 to determine the portions of the initial video features tensor corresponding to 0≤k′≤k faces to use in the computation of the plurality of enhanced audio features.

Optionally, in a scenario of k′=0, wherein an active speaker is not present in the scene observed by the camera 102, as in case of an occluded speaker, in case the user is the active speaker, or in case the image of the speaker leaves the scope of the camera 102, the transcription module 140 receives the tensor of initial audio features directly from the audio feature extraction module 110. Responsive to an interrupted availability of an active speaker image, the speaker module 210 reduces the relevance weights assigned to the video features 310. Responsive to a resumed availability of an active speaker image, the speaker module 210 increases the relevance weights assigned to the video features 310 accordingly.

In an embodiment, the speaker module 210 receives auxiliary input data from one or more additional sensors, such as a position tracker, a radio-frequency identification (RFID) device, or another sensor capable of providing information to assist in identifying or tracking individuals within a scene. Examples of such auxiliary input data include positional data, movement trajectories, identity markers, and environmental context information. Optionally, the speaker module 210 computes a plurality of initial auxiliary features by processing the auxiliary input data. In an example, from a position tracker, the speaker module 210 extracts spatial coordinates and velocity data, which may be used to infer the trajectory of an individual or correlate their position with the video frame. In another example, from an RFID device, the speaker module 210 extracts identity data, timestamped movement information, and proximity to tagged entities, enabling robust tracking of individuals in dynamic environments even when they temporarily leave the video frame or become obscured. In another example, from other sensors such as temperature or environmental sensors the speaker module 210 derives contextual features, such as the relative positions of individuals based on heat signatures.

Optionally, the speaker module 210 processes the auxiliary input data, thereby generating a plurality of initial auxiliary features and utilizing in part said plurality of initial auxiliary features to generate a plurality of speaker features 340.

In an embodiment, the selection module 220 receives a plurality of speaker features 340 from the speaker module 210 and processes it to output a sequence of discrete non-negative speaker labels 221 in the [0, K] range, wherein the 0 label corresponds to the user of the system, and each of the positive labels corresponds to an individual face present in the input video captured by the camera 102. For example, the selection module 220 may comprise a convolutional neural network (CNN) and maintain an internal state to enhance accuracy, the internal state comprising previously established speaker labels 221, a speaker-specific vocabulary, filler words such as “okay,” commonly used word patterns, or the contextual relevance of preceding utterances.

Optionally, the selection module 220 receives the text transcription 141 from the transcription module 140 in a form of a sequence of textual tokens and utilizes it to maintain the validity of the speaker label sequence 221. For example, the selection module 220 may apply a machine learning model to the text transcription 141 and the speaker features 340 to enhance the accuracy and temporal coherence of the speaker label sequence 221. For example, the text transcription 141 may inform the machine learning model to avoid inappropriately switching a speaker label 221 in the middle of a word or a sentence.

The integration process may combine current speaker features 340 with historical text transcriptions 141 by aligning temporal data, ensuring that speaker labels 221 remain consistent across the duration of a coherent spoken phrase. Optionally, the machine learning model, such as a recurrent neural network or transformer-based model, processes the concatenated features, using attention mechanisms or sequential patterns to align textual and speaker features effectively. By maintaining a history of both text transcriptions 141 and speaker labels 221, the machine learning model can resolve ambiguities and ensure speaker continuity even in complex conversational scenarios. Optionally, the selection module 220 performs diarization of the text transcription 141, associating specific transcribed speech utterances and continuous speech segments with their corresponding speaker labels 221.

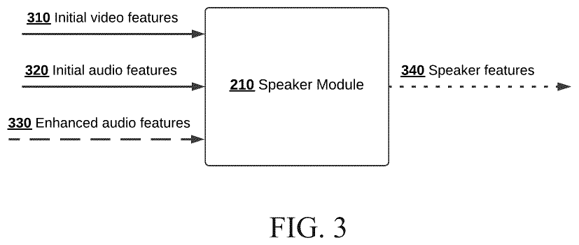

Reference is now made to FIG. 3, which is a schematic diagram of the speaker module. According to some embodiments of the invention, the speaker module 210 accepts as input a 3-dimensional tensor of initial video features 310, a sequence of initial audio features 320 and a sequence of enhanced audio features 330.

Optionally, the speaker module 210 assumes a maximum of K distinct faces in a video input captured by the camera 102, thereby accepting an initial video features tensor 310 of a dimension [F·T]×V×K, wherein T is the duration of the video sample size in seconds, F is the frame rate of the RGB frames captured by the camera 102, and V is the size of an initial video feature vector. In an example, V=512 and F=25 Hz.

Optionally, the sequence of initial audio features 320 and the sequence of enhanced audio features 330 both comprise tensors of a dimension [R·T]×W, wherein T is the duration of the audio sample size in seconds, R is the audio feature rate in vectors per second, and W is the width of an audio feature vector, representing local acoustic characteristics of a brief time interval. In an example, W=1280 and R=50 Hz.

Optionally, the speaker module 210 processes a combination of the initial video features 310, the initial audio features 320 and the enhanced audio features 330 with a recurrent neural network configured to produce a sequence of vectors encoding identity of a speaker of a preconfigured length D for each time frame, thereby outputting a tensor of speaker features of a dimension [R·T]×D. A vector encoding identity of a speaker may comprise a value corresponding to absence of a valid speaker in the initial video features 310.

Optionally, the speaker module 210 may explicitly perform analysis of voice characteristics in the initial audio features 320, detect facial movements in the initial video features 310, or perform other joint analysis of the initial audio and video features 310, 320.

In an embodiment, the speaker module 210 applies a decision process to the plurality of initial audio features 310 and the plurality of initial video features 320. The decision process may leverage machine learning techniques such as a decision forest or gradient-boosted trees to classify or regress on the initial audio and video features 310, 320. Each decision tree evaluates the input based on learned thresholds and criteria, producing an intermediate output. The outputs of all decision trees in the forest are aggregated to form the final decision, which influences the generation of the speaker features 340.

In another embodiment, the speaker module 210 utilizes a recurrent neural network that automatically learns the characteristics of speakers present in the initial audio and video features 310, 320. In another example, the speaker module utilizes a recurrent neural network that also receives a plurality of previously computed speaker features 340.

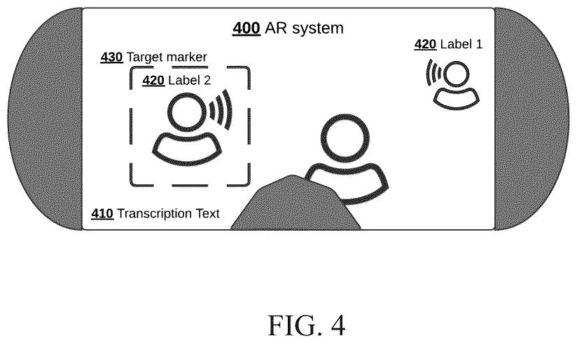

Reference is now made to FIG. 4, which illustrates a schematic representation of an augmented reality (AR) device view. According to some embodiments of the invention, the AR system 400 is configured to assist the user in visualizing and interacting with the transcription process during a conversation or meeting, and superimposes information on the display in real time. Optionally, the invention comprises a virtual reality device in place of an augmented reality device.

Optionally, the information comprises a transcription text 410 of utterances produced by a target speaker. Optionally, the AR system 400 displays the transcription text 410 in a preconfigured section of the view. Optionally, the AR view 400 displays the transcription text 410 in a section of the view visually adjacent to a current target speaker.

Optionally, the AR system 400 accumulates a transcription buffer of a preconfigured duration and periodically replaces the entirety of a currently displayed transcription text 410 with contents of the transcription buffer, truncating the transcription buffer. For example, the AR system 400 executes this process responsive to a timer event, responsive to a trigger event such as accumulation of a preconfigured count of text tokens in the transcription buffer, or responsive to a combination of events.

Optionally, the AR system 400 updates the transcription text 410 by removing one or more oldest tokens in the transcription and appending one or more newest tokens in the transcription, responsive to preconfigured trigger events such as timer events or accumulation of a preconfigured count of text tokens in the transcription buffer.

Optionally, the auxiliary information comprises a plurality of speaker labels 420. The AR system 400 may display a speaker label 420 for at least one of a target speaker, each of a plurality of identified active speakers, each of a plurality of previously active speakers, or a combination of the above. Optionally, the AR system 400 may impose filters on the plurality of identified active speakers or the plurality of previously active speakers. In an example, the AR system 400 may only display a speaker label 420 if an active speaker occupies a portion of the view greater than a preconfigured threshold or according to a different criterion. In another example, the AR system 400 may only display a speaker label 420 if a previously active speaker has ceased speaking at a time point more recent than a preconfigured threshold or according to a different criterion.

In an embodiment, the AR system 400 enables a user to target a specific individual for further speech transcription. Responsive to the user targeting an individual, the AR system 400 prioritizes and tracks the individual, leveraging their speaker characteristics in case of a brief disruption of their visual or auditory presence.

Optionally, tracking an individual comprises seeking a face of the individual in subsequent RGB frames captured by the camera 101, and utilizing or emphasizing video features corresponding to the face in the subsequent RGB frames.

In an embodiment, the AR system 400 comprises one or more microphones 101, one or more cameras 102, a display and a processing unit in a unitary device. In another embodiment, the processing unit comprises a physically separate device such as a smartphone, a remote server or a cloud instance, and is coupled to the one or more cameras 102, the one or more microphones 101 and the display over a network path comprising at least one wireless link. Optionally, the wireless link may comprise one of a Bluetooth, Wi-Fi, Wi-Fi Direct, Wi-Fi HaLow, Ultra-Wideband, mmWave, 5G, and LiFi connection.

In another embodiment, the AR system 400 comprises one or more microphones 101, one or more cameras 102 and a processing unit in a unitary device and does not comprise a display.

Optionally, the AR system 400 displays the transcription text 410 on an auxiliary display such as the screen of the physically separate device such as a smartphone or an auxiliary projector device.

In an embodiment, the AR system 400 determines whether the currently active speaker corresponds to the user of the AR system 400. If the determination is affirmative, the AR system 400 suppresses the display of the transcription text 410, clearing it from the view. Optionally, said determination may comprise comparing the current speaker label 221 output by the selection module 220 with a predetermined value designated to the application's user such as zero. Optionally, as long as the determination is affirmative, the AR system 400 skips operation of the transcription module 140 entirely. The transcription text 410 remains suppressed until the determination becomes negative, at which point the AR system 400 resumes displaying transcription text. This behavior addresses the expectation that a user of the AR system 400 is not merely a passive listener but may also contribute to a conversation or a meeting as an active speaker. Displaying the transcription text 410 of the user's own speech during such interactions could detract from the user experience, as it may be distracting or unnecessary. By detecting and omitting displaying the transcription text 410 of the user's own speech, the AR system 400 enhances usability and ensures a more seamless experience for the user.

Optionally, the AR system 400 produces a plurality of transcription texts 410 of utterances produced by a respective plurality of speakers, and displays each transcription text 410 adjacent to a respective speaker's face.

Optionally, the AR system 400 enables a user to target a specific individual by centrally positioning the individual's face and maintaining its position the center of the view for a predefined duration.

Optionally, the AR system 400 enables a user to target a specific individual by centrally positioning the individual's face and performing a tactile gesture on the AR glasses such as tap or a button press.

Optionally, the AR system 400 enables a user to target a specific individual by tapping on a portrait of the individual displayed by a smartphone application.

Optionally, the AR system 400 enables a user to target a specific individual by performing a physical gesture such as a pointing gesture directed towards the individual.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of target speaker recognition and transcription of speech, comprising:
receiving an audio stream from a first input;
receiving a video stream from a second input;
computing a plurality of initial audio features from the audio stream;
computing a plurality of initial video features from the video stream;
applying a neural network to the plurality of initial video features, thereby generating a plurality of extended video features;
determining a correlation between the plurality of initial audio features and the plurality of extended video features, thereby generating a plurality of enhanced audio features;
processing the plurality of initial audio features, the plurality of initial video features and the plurality of enhanced audio features, thereby generating a plurality of target speaker features; and
generating an output.

2. The method according to claim 1, further comprising:
receiving a data stream from a third input; and
computing a plurality of initial auxiliary features from the data stream,
wherein generating a plurality of target speaker features comprises processing the plurality of initial audio features, the plurality of initial video features, the plurality of enhanced audio features and the plurality of initial auxiliary features.

3. The method according to claim 1, wherein the neural network comprises at least one convolution layer.

4. The method according to claim 1, wherein generating the plurality of enhanced audio features comprises performing a computation solely on the plurality of extended video features.

5. The method according to claim 1, wherein generating the plurality of enhanced audio features comprises one or more of:
applying at least one cross-attention layer to the plurality of initial audio features and the plurality of extended video features;
applying a recurrent neural network to the plurality of initial audio features, the plurality of initial video features and a plurality of previously computed target speaker features; and
utilizing a decision process to the plurality of initial audio features, the plurality of initial video features and a plurality of previously computed target speaker features.

6. The method according to claim 1, wherein generating the plurality of target speaker features comprises applying a recurrent neural network to the plurality of initial audio features, the plurality of initial video features and the plurality of enhanced audio features.

7. The method according to claim 1, wherein generating an output comprises:
applying a machine learning model to the plurality of target speaker features, thereby generating a target speaker label; and
outputting the target speaker label.

8. The method according to claim 1, wherein generating an output comprises:
applying positional encoding to the plurality of enhanced audio features;
applying at least one transformer encoder layer, thereby generating a sequence of encoded vectors;
applying a transformer decoder layer to the sequence of encoded vectors, thereby generating a sequence of textual tokens;
concatenating the sequence of textual tokens, thereby generating a text transcription; and
outputting the text transcription.

9. The method according to claim 8, further comprising:
applying a machine learning model to the plurality of target speaker features and at least one of a previously obtained text transcription and a previously obtained plurality of textual tokens, thereby generating a target speaker label; and
outputting the target speaker label.

10. The method according to claim 9, further comprising:
determining whether a condition is met, wherein the condition comprises checking whether the target speaker label equals to a predetermined speaker label; and
responsive to determining that the condition is met, skipping the step of outputting the text transcription.

11. The method according to claim 1, wherein computing a plurality of initial audio features comprises:
receiving an audio signal from a microphone device;
computing a spectrogram of the audio signal; and
applying at least one convolution layer to the spectrogram.

12. The method according to claim 1, wherein computing a plurality of initial video features comprises:
receiving a frame sequence from a camera device;
responsive to detection of one or more faces within a frame in the frame sequence, determining a bounding box for each detected face; and
extracting from the frame a 2-dimensional (2D) array of pixels limited by the respective bounding box for each detected face.

13. The method according to claim 12, further comprising:
responsive to detecting absence of a target speaker in the plurality of video streams:
skipping the step of generating a plurality of extended video features;
skipping the step of generating a plurality of enhanced audio features; and
processing the plurality of initial audio features, thereby generating a plurality of target speaker features; and
generating an output.

14. The method according to claim 12, further comprising:
detecting a particular face at the center of each frame in the frame sequence of a configured duration;
tracking the detected face across subsequent frames; and
prioritizing the target speaker features corresponding to the tracked face across subsequent frames.

15. The method according to claim 12, further comprising:
receiving a signal to select a particular face from a third input;
tracking the selected face across subsequent frames; and
prioritizing the target speaker features corresponding to the tracked face across subsequent frames.

16. A computer system, comprising
one or more microphone devices;
one or more camera devices;
a processor configured to execute stored executable instructions; and
a non-transitory computer readable medium storing executable instructions that, when executed by a processor, cause the computer system to perform a method of target speaker recognition and transcription, the method comprising:
receiving one or more audio streams as a first input;
receiving one or more video streams a second input;
computing a plurality of initial audio features from the one or more audio streams;
computing a plurality of initial video features from the one or more video streams;
applying a neural network to the plurality of initial video features, thereby generating a plurality of extended video features;
determining a correlation between the plurality of initial audio features and the plurality of extended video features, thereby generating a plurality of enhanced audio features;
processing the plurality of initial audio features, the plurality of initial video features and the plurality of enhanced audio features, thereby generating a plurality of target speaker features; and
generating an output.

17. The computer system according to claim 16, further comprising one of an augmented reality display and virtual reality display, wherein generating an output comprises rendering a text transcription on the one of an augmented reality display, an auxiliary screen, an auxiliary projector or a virtual reality display.

18. The computer system according to claim 16, wherein at least one of the one or more microphone devices and the one or more camera devices is coupled to the processor via at least in part a wireless link.

19. The computer system according to claim 18, wherein the wireless link comprises one of a Bluetooth, Wi-Fi, Wi-Fi Direct, Wi-Fi HaLow, Ultra-Wideband, mmWave, 5G, and LiFi connection.
